(19) United States
(12) Patent Application Publication
(10) Pub. No.: US 2015/0113405 A1
(43) Pub. Date: Apr. 23, 2015

(54) SYSTEM AND A METHOD FOR ASSISTING PLURALITY OF USERS TO INTERACT OVER A COMMUNICATION NETWORK

(71) Applicant: Ravi Puri, Aliso Viejo, CA (US)

(72) Inventor: Ravi Puri, Aliso Viejo, CA (US)

(21) Appl. No.: 14/495,894

(22) Filed: Sep. 25, 2014

Related U.S. Application Data
(60) Provisional application No. 61/893,416, filed on Oct. 21, 2013.

(51) Int. Cl. G06F 3/0484; G06F 17/30; H04L 29/06

(52) U.S. Cl. CPC G06F 3/0484; H04L 65/403; G06F 17/30091
USPC 715/719

(57) ABSTRACT

Disclosed is a system and a method for assisting plurality of users to interact over a communication network. The system includes a first computing device and a second computing device of a second user communicating to the first computing device over the communication network. The first computing device includes first computer executable components such as a selection component for selecting at least a first media file by the first user, and a sharing component for sharing the selected first media file with a second user. The second computing device includes second computer executable components such as a recording component for recording a first feedback media file by the second user while viewing the first media file received from the first user, and a second sharing component for sharing the first feedback media file by the second user to the first user.

### CROSS-REFERENCE TO RELATED APPLICATION

This application claims priority to a U.S. Provisional Application No. 61/893,416 filed on Oct. 21, 2013; the entire contents of which are incorporated herein by references in its entirety.

### BACKGROUND OF THE DISCLOSURE

1. Field of the Invention

The present invention generally relates to a system and a method for assisting plurality of users to interact over a communication network, and more particularly relates to a system and a method for providing a platform for creating, sharing and recording data for interaction between two or more users.

2. Description of Related Art

With recent technology enhancements providing a platform for global teaching and work environments, online interaction is a necessity for everyone. There has been a growth in online knowledge transfer with teachers sharing their knowledge through an online platform. Then, students respond on the knowledge received from a teacher through the online platform. Thus, interaction among teachers and students occurs in the case of online teaching. Similarly, the same knowledge transfer may occur among parents and children, managers and employees, and in other related scenarios.

Various software products are provided for online interaction such as gotomeeting, skype and WebEx etc. that allow visual interaction among users. Further, these software products provide various online meeting features; however, both users must be online together to interact.

In addition, various software products are provided for uploading a video message to an Internet website and/or e-mail or webmail inbox that can be viewed by another user. Then that other user can upload a response for that message. However, these software products do not provide any interface to allow users to record feedback in real-time as a response within the same viewed message. Therefore, there is a need of a system and a method to provide a platform for creating, sharing and recording data for interaction between at least two users that resolves the shortfalls of the software products above.

### SUMMARY OF THE INVENTION

In accordance with the teachings of the present invention, a system and a method for assisting plurality of users to interact over a communication network is provided. The system includes a first computing device of a first user and a second computing device of a second user communicating with the first computing device over a communication network. The first computing device includes a first database for storing one or more media files and first computer executable components, and a first processor coupled with the first database to execute the first computer executable components. The first computer-executable components includes a selection component for selecting at least a first media file by the first user, and a first sharing component for sharing the first media file with a second user.

The second computing device includes a second database for storing one or more media files and second computer executable components. The second computing device further includes a second processor coupled with the second database to execute the second computer executable components. The second computer executable components includes a recording component for recording a first feedback media file by the second user while viewing the first media file received from the first user, and a second sharing component for sharing the first feedback media file by the second user to the first user.

An object of the present invention is to provide a system and a method for providing a platform for visual interaction between at least two users.

Another object of the present invention is to provide a system and a method for assisting one or more users to interact over a communication network. The system includes a computing device comprising a processor coupled with a database to execute the computer executable components. The computer executable components includes a selection component for selecting at least a first media file by the first user, a viewing component for viewing the first media file selected by the first user, and a recording component for recording a first feedback media file by the first user while viewing the first media file.

These and other objects, features and advantages of the invention will become more fully apparent in the following detailed description, taken in conjunction with the accompanying drawings.

### BRIEF DESCRIPTION OF DRAWINGS

The disclosure will provide details in the following description of preferred embodiments with reference to the following figures wherein:

FIG. 1 illustrates a block diagram of a system for assisting plurality of users to interact over a communication network, in accordance with a preferred embodiment of the present invention;

FIG. 2A illustrates a screenshot showing, by way of an example, a user interface (UI) of the selection component for selecting at least a media file stored in a first computing device, in accordance with an embodiment of the present invention;

FIG. 2B illustrates a screenshot showing, by way of an example, a UI of the sharing component for sharing the selected media file from the first computing device to a second computing device, in accordance with an embodiment of the present invention;

FIG. 3A illustrates a screenshot showing, by way of an example, a UI of the picture-in-picture window frame module, in accordance with an embodiment of the present invention;

FIG. 3B illustrates a screenshot showing, by way of an example, another UI of the picture-in-picture window frame module, in accordance with an embodiment of the present invention;

FIG. 4 illustrates a screenshot showing, by way of an example, a UI of second sharing component for sharing the first feedback media file by the second user to the first user in accordance with an embodiment of the present invention;

FIG. 5 illustrates a flow chart of a method for assisting plurality of users to interact over a communication network, in accordance with an embodiment of the present invention; and

FIG. 6 illustrates a block diagram of the system for assisting one or more users to interact over a communication network, in accordance with an alternative embodiment of the present invention;

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF DRAWINGS

While this technology is illustrated and described in a preferred embodiment, a system and a method for assisting plurality of users to interact over a communication network may be produced in many different configurations, forms and materials. There is depicted in the drawings, and will herein be described in detail, as a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the technology described herein.

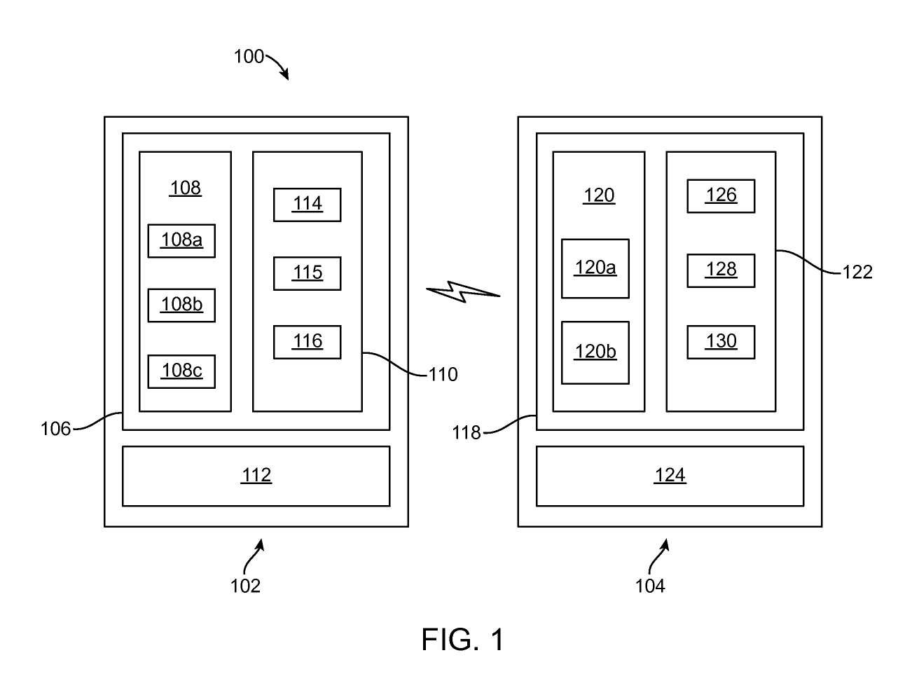

FIG. 1 illustrates the block diagram of the system 100 for assisting plurality of users to interact over a communication network. Examples of the communication network include but not limited to are Wi-Fi, Bluetooth, Wi-max, internet, intranet, ZigBee, ANT, and NFC. The system 100 includes a first computing device 102 of a first user, and a second computing device 104 of a second user communicating to the first computing device over the communication network. The first computing device 102 includes a first database 106 for storing one or more media files 108 and first computer executable components 110. The first computing device 102 further includes a first processor 112 coupled with the first database 106 to execute the first computer executable components 110. The first computer executable components 110 include a selection component 114 and a sharing component 116.

The second computing device 112 includes a second database 118 for storing one or more media files 120 and second computer executable components 122. The second computing device 104 further includes a second processor 124 coupled with the second database 118 to execute the second computer executable component 122. The second computer executable components 122 include a recording component 126 and a second sharing component 128.

Examples of the first computing device 102 and the second computing device 104 include but not limited to personal computer, mobile telephone, portable computer including tablet computer, laptop computer and notebook computer, and personal digital assistant.

In the preferred embodiment of the present invention, the first computer executable component 110 and the second computer executable component 122 are configured to be respectively executed by the first computing device 102 and second computing device 104. Hereinafter, the media files 108 and the feedback media files 120 are described as the media files 108, 120.

In the preferred embodiment, the media files 108,120 may be a video file, such as a video clip, a movie, an animation clip, a television program recording, or a video recording, that is available through the computing device through any method, including but not limited to a video file downloaded to the computing device, a video file created by the computing device, or an online video file streaming from a website such as Youtube.com. In one embodiment, the media files 108, 120 may be an audio file, such as a song, a speech, recorded sound, or audio clip. In an exemplary embodiment, a media file is a television broadcast, or a radio broadcast. In another exemplary embodiment, a media file is an article, such as a book, a piece of news, written paper, spreadsheet, or presentation slides. In another exemplary embodiment, the media files 108, 120 may be a picture, such as a photo, graphical image, graph, or table.

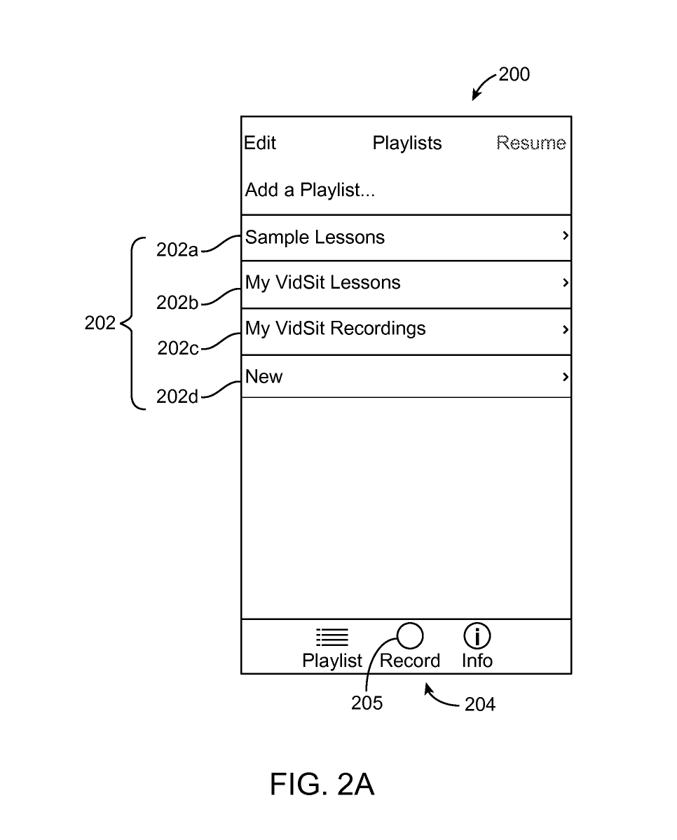

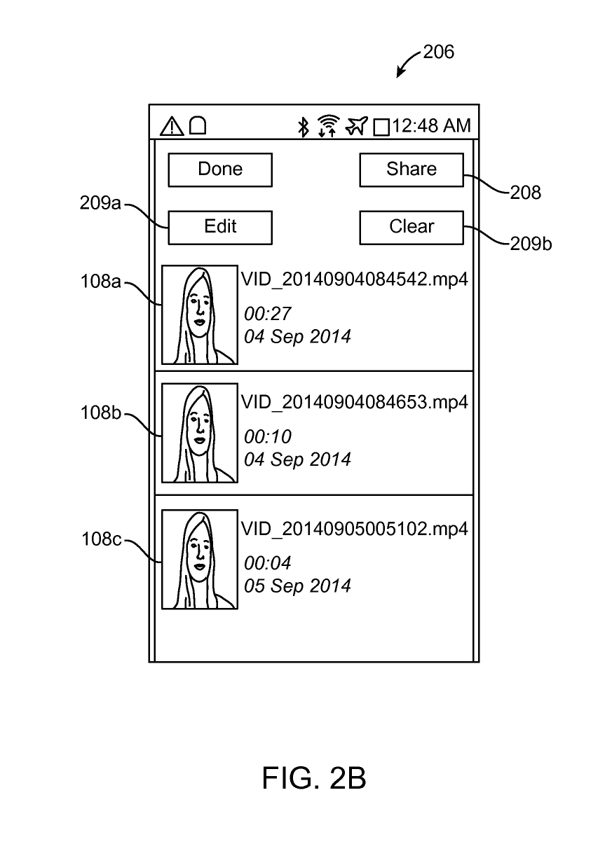

The selection component 114 enables the first user to select the first media file 108a. For example the selection component 114 enables the first user to select the first media file 108a pre-stored on the first database 106. In a preferred embodiment of the present invention, the first media file 108a is a recorded video clip. However, it will be readily apparent to those skilled in the art that various forms of media file may be envisioned without deviating from the scope of the present invention. Further, in another embodiment of the present invention, the selection component may allow the first user to download the first media file 108a from the communication network. The selection component 114 is explained in detail in conjunction with FIG. 2A of the present invention.

The first sharing component 116 enables the sharing of the first media file 108a with a second user via communication network. For example, the sharing component 116 enables the first user to share the first media file 108a through popular video sharing websites. Examples of sharing options include but are not limited to e-mail, airdrop, Facebook, Whatsapp, Youtube, and metacafe. However, it will be readily apparent to those with ordinary skill in the art that the various other types of media file sharing options may also be used without deviating from the scope of the present invention. The sharing component 116 is explained in detail in conjunction with FIG. 2B of the present invention.

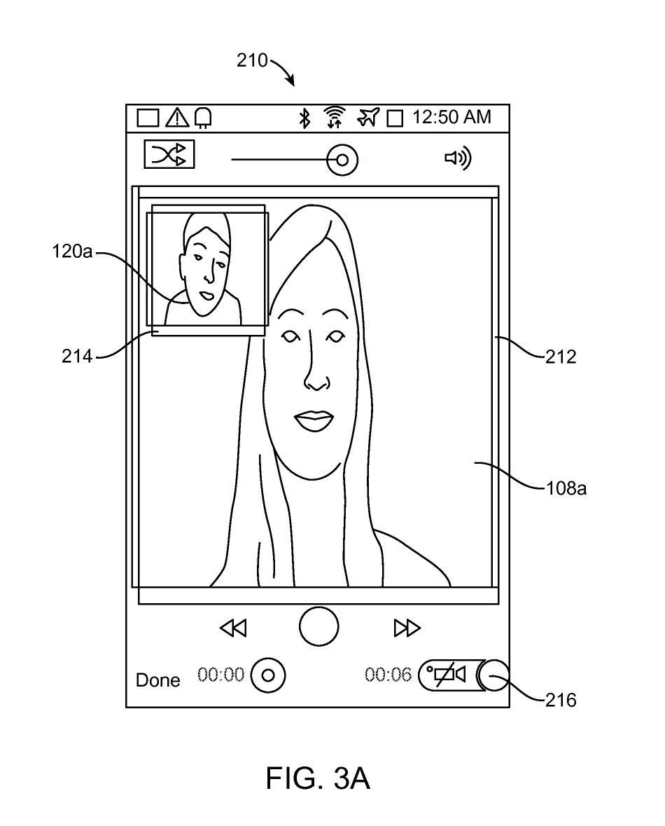

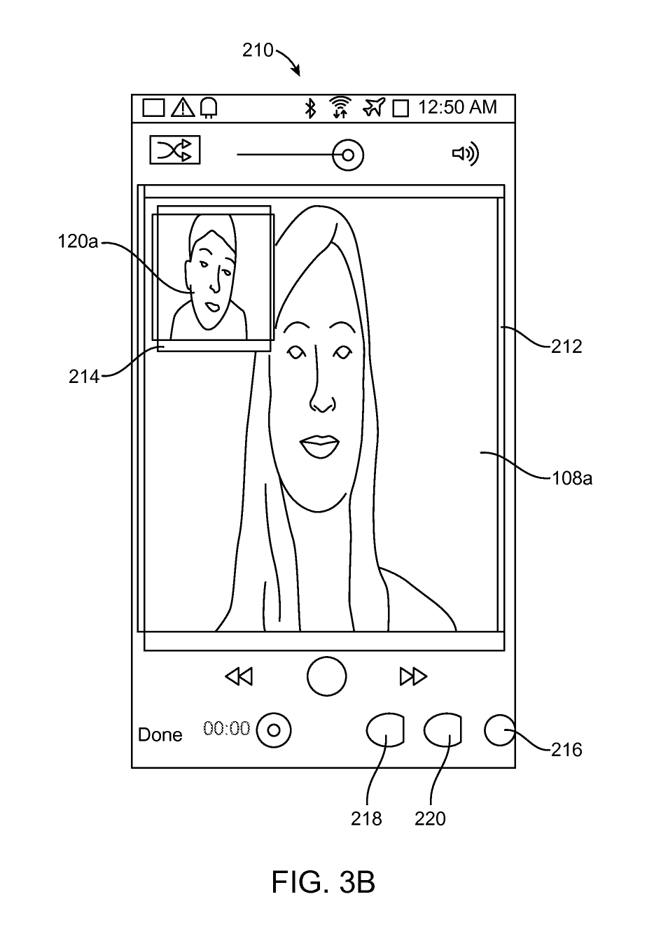

The recording component 126 enables the second user to record a first feedback media file 120a while viewing the first media file 108a received from the first user. In a preferred embodiment of the present invention, the recording component 126 is associated with a front camera to record the first feedback media file 120a while viewing the first media file 108a. Further in an exemplary embodiment, the first feedback media file 120a is a response to the first media file 108a. The recording component is explained in detail in conjunction with FIG. 3A of the present invention.

The second sharing component 128 is executable by the second processor 124 for sharing the first feedback media file 120a by the second user to the first user. In another preferred embodiment of the present invention, the second sharing component 128 may share the first feedback media file 120a with various computing devices through the communication network. The second sharing component 128 is explained in detail in conjunction with FIG. 3B of the present invention.

In another preferred embodiment of the present invention, the selection component 114 further includes a creation module for creating a second media file 108b by the first user. The creation module is explained in detail in conjunction with FIG. 2A of the present invention. In a preferred embodiment of the present invention, the second media file 108b is a new video clip created by the first computing device 102.

In the preferred embodiment of the present invention, the recording component 126 further includes a picture-in-picture window frame module for simultaneously displaying the first media file 108a and the first feedback media file 120a in separate window frames. In another preferred embodiment of the present invention, the first media file 108a received from the first user is displayed in a main background window frame, and the first feedback media file 120a is displayed in a record window frame within the main background window frame. The picture-in-picture window frame module is explained in detail in conjunction with FIG. 3A of the present invention.

In the preferred embodiment of the present invention, the recording component 126 further includes a pause module for allowing the second user to pause the first media file 108a received from the first user; and a time-set module for setting a time interval to pause the first media file 108a at a fixed interval of time. The pause module and time-set module are explained in detail in conjunction with FIG. 3A of the present invention.

In the preferred embodiment of the present invention, the first computing device 102 further includes a second recording component 115 for recording a second feedback media file 108c in the first database 106 while viewing the first media file 108a, wherein the first sharing component 116 shares the second feedback media file 108c over the communication network. The second feedback media file 108c is similar to the example of the first media file 120a explained in detail in conjunction with FIG. 3A and FIG. 3B of the present invention.

In the preferred embodiment of the present invention, the second computing device 104 further includes a second selection component 130 for selecting at least one media file 120b from the second database 118, wherein the second sharing component 128 shares the selected media file 120b over the communication network. The selection of the media file 120b is similar to the example of the first media file 108a explained in detail in conjunction with FIG. 2A of the present invention.

FIG. 2A illustrates a screenshot showing, by way of an example, a UI 200 of the selection component 202 for selecting the first media file from first database, in accordance with the preferred embodiment of the present invention. The UI 200 enables the first user to select the first media file in the selection component 202. Examples of the selection component 202 includes but is not limited to are “Sample Lessons 202a”, “My VidSit Lessons 202b”, “My VidSit Recordings 202c”, and “New 202d”, which may be any new selection component created by the first user. The selection component 202 enables the user to select pre-stored media files from the database.

The UI 200 further displays a creation module 204 to create a new second media file. The creation module 204 allows the user to record by clicking the record button 205. The creation module 204 is associated with any acquisition unit for an example, the camera to record video, audio and any other media file. The creation module 204 is associated with My Vidsit Lessons 202b, i.e. the media files created through the creation module 204 are saved in the My Vidsit Lessons 202b. Example of the new second media file is similar to the example of the first media file as explained in detail in conjunction with FIG. 1 of the present invention.

FIG. 2B illustrates a screenshot showing, by way of an example, a UI 206 of the first sharing component 208 for sharing at least one of one or more media files 108a, 108b, 108c, in accordance with the preferred embodiment of the present invention.

The UI 206 displays the first sharing component 208 to share at least one of one or more media files 108 through the communication network. For an example, in the preferred embodiment the first media file 108a may be shared by the first user with the second user through e-mail.

The UI 206 further displays an edit option 209a for performing one or more editing operations in at least one of the one or more media files 108a, 108b, 108c and a clear option 209b for clearing at least one or more media files 108a, 108b, 108c. Examples of the one or more editing operations for media files 108a, 108b, 108c includes but not limited to are renaming the first media file 108a, cropping the first media file 108a, changing the format of the first media file 108a. Examples of clearing option for media files 108a, 108b, 108c include but not limited to deleting the first media file 108a from the ‘My VidSit Lessons’ selection component.

FIG. 3A illustrates a screenshot of the UI 210 of picture-in-picture window frame module on the second computing device, in accordance with the preferred embodiment of the present invention. The UI 210 displays a record option 216 for recording the first feedback media file 120a, while playing the first media file 108a in the main background window frame 212.

In a preferred embodiment of the present invention, the second user is able to view the first media file 108a and records the first feedback media file 120a as a response to the message provided in the first media file 108a. For example, the first media file 108a may be a recorded video lesson, and the first feedback media file 120a may be a recorded video including the response by the learner.

The first media file 108a is played in the main background window frame 212 for allowing the second user to view the actions and the message provided by the first user. Thus, the second user gets a broader area to see the message in the main background window frame 212. Similarly, the first feedback media file 120a is displayed in a record window frame 214, a relative smaller area as to the main background window frame 212.

However, it would be readily apparent to those skilled in the art that various other formats of displaying the first media file 108a and the first feedback media file 120a may be envisioned without deviating from the scope of the present invention. In another preferred embodiment, the record window frame 214 is displayed at the left-hand top corner portion within the main background window frame 212.

In another preferred embodiment of the present invention, the first media file 108a in the main background window frame 212 is simultaneously displayed and recorded with a first feedback media file 120a in a record window frame 214, when the record option 216 is selected by the second user.

Furthermore, it will be readily apparent to those with ordinary skill in the art that the main background window frame 212 and record window frame 214 may be of any width, height, dimension or total area without deviating from the scope of the present invention.

FIG. 3B illustrates a screenshot of another UI 210 for displaying the picture-in-picture window frame module on the second computing device. The UI 210 further displays a pause module 218 to pause the first media file 108a played in the main background window frame 212, at the time of recording the first feedback media file 120a. For example, in the preferred embodiment, when the user selects pause module 218, the first media file 108a is paused. In another preferred embodiment, the first feedback media file 120a is also paused when the user selects pause module 218.

The UI 210 further displays a time-set module 220 to set the time interval to pause the first media file 108a played in the main background window frame 212 at a fixed interval of time, at the time of recording the first feedback media file 120a. For example in the preferred embodiment, when the user selects a time interval in the time-set module 220, such as 2 minutes, the first media file 108a is paused consecutively at regular 2 minute time intervals, and after audio from the user, or the user's surrounding, is captured by the computing device's microphone, the first media file 108a is played again for another 2 minute time interval. In another preferred embodiment, the recording of first feedback media file 120a is also paused at the same fixed interval of time as the first media file 108a.

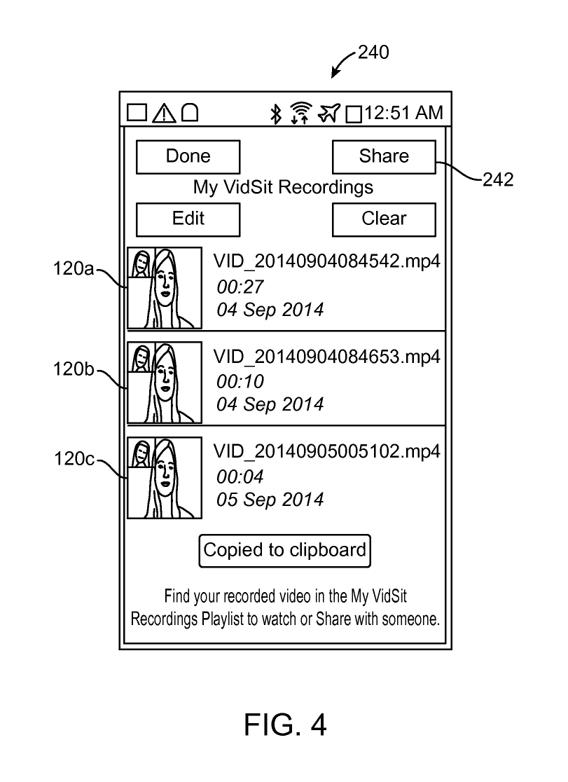

FIG. 4 illustrates a screenshot showing, by way of an example, a UI 240 of the second sharing component 242 for sharing the first feedback media file 120a selected from one or more media files 120a, 120b, 120c by the second user with the first user in accordance with an embodiment of the present invention. The first feedback media file 120a is shared over the communication network. For example, the first feedback media file 120a may be shared from the second user to the first user through e-mail.

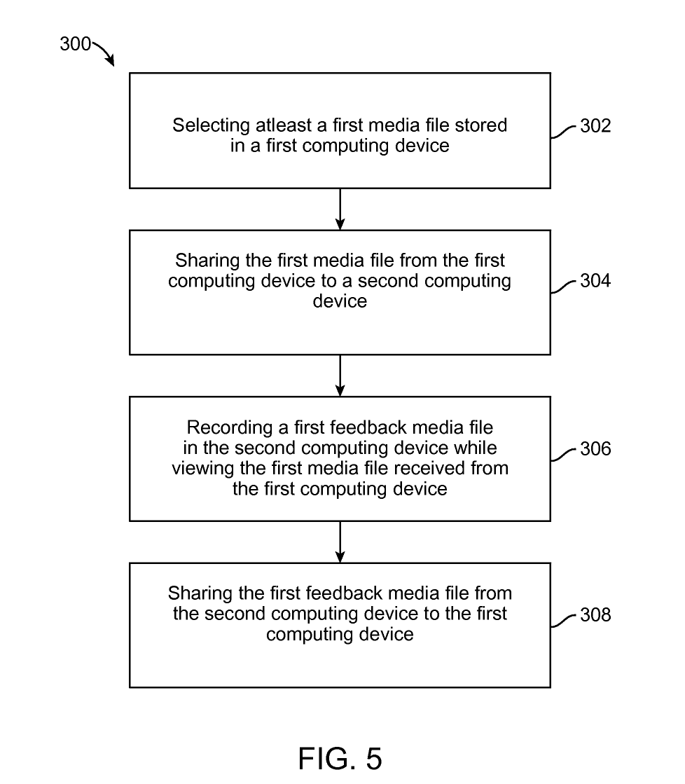

FIG. 5 illustrates a flow chart of a method 300 for assisting plurality of users to interact over a communication network. The method 300 initiates with a step 302 of selecting a first media file stored in a first computing device. The step 302 is followed by a step 304 of sharing the first media file from the first computing device to a second computing device. The step 302 and step 304 are explained in conjunction with the FIG. 1, FIG. 2A and FIG. 2B of the present invention.

The step 304 is followed by a step 306 of recording a first feedback media file in the second computing device while viewing the first media file received from the first computing device. The step 306 is followed by a step 308 of sharing the first feedback media file from the second computing device to the first computing device. The step 306 and step 308 are explained in conjunction with the FIG. 1, FIG. 3A, FIG. 3B and FIG. 4 of the present invention.

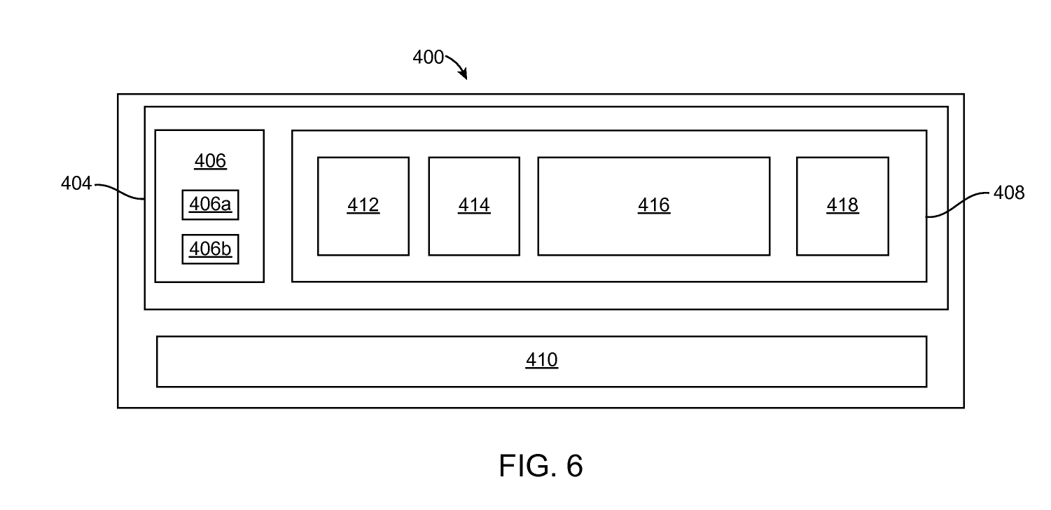

FIG. 6 illustrates a block diagram of the system 400 for assisting a first user to interact with the media file in accordance with the alternative embodiment of the present invention. The system 400 includes a database 404 for storing one or more media files 406 such as media file 406a, 406b and computer executable components 408. The system 400 further includes a processor 410 coupled with the database 404 to execute the computer executable components 408.

The computer executable components 408 include a selection component 412, a viewing component 414, and a recording component 416. The selection component 412 selects at least a first media file 406a by the first user. The selection component 412 enables the first user to select a first media file 406a stored on the database 404. In the alternative embodiment of the present invention, the first media file is a recorded video clip. The selection component 412 performs similar functions as of the selection component 114 and is explained in detail in conjunction with FIG. 2A of the present invention.

The viewing component 414 enables the viewing of the first media file 406a selected by the first user. For example, the first media file 406a is the recorded video clip which may be viewed by video media player that includes but not limited to Amiga media players, Android media players, Apple iOS media players, Client/server media players, and DOS media players. However, it will be readily apparent to those with ordinary skill in the art that there are various other types of Internet browser and computing device applications used to view the selected media file 406a without deviating from the scope of the present invention.

The recording component 416 records a feedback media file 406b while viewing the first media file 406a played by the first user. In this alternative embodiment of the present invention, the recording component 416 is associated with any acquisition unit for an example, the camera to record the feedback media file 406b while viewing the first media file 406a. Further, the recorded feedback media file 406b is a response to the first media file 406a. The recording component 416 performs similar functions as of the recording component 126 explained in detail in conjunction with FIG. 3A of the present invention.

It would be known to those skilled in the art, that the examples of the database 404 is similar to first database 110 and second database 122 and are explained in detail in conjunction with FIG. 1 of the present invention. Similarly, the examples of first media file 406 is similar to the examples of the first media file 108, feedback media files 120, and second media file 108b and are explained in detail in conjunction with FIG. 1 and FIG. 2A of the present invention.

In the alternative embodiment of the present invention, the selection component 412 further includes a creation module for creating a second media file by the first user. The creation module is explained in detail in conjunction with FIG. 2A of the present invention. The creation module allows the user to record a view by clicking a record button. The creation module is associated with any acquisition unit for an example, the camera to record video, audio and any other media file.

In the alternative embodiment of the present invention, the recording component 416 further includes a picture-in-picture window frame module for simultaneously displaying first media file 406a and the feedback media file 406b in separate window frames. The picture-in-picture window frame module is explained in detail in conjunction with FIG. 3A of the present invention. The first media file 406a is displayed in a main background window; and the feedback media file 406b is displayed in a record window within the main background window.

In the alternative embodiment of the present invention, the system 400 further includes a sharing component 418 to share the feedback media file 406b to a second computing device (not shown in FIG. 6). For example, the sharing component 418 enables the first user to share the first media file 108a through e-mail or any other sharing method over a communication network. The sharing component 418 is explained in detail in conjunction with FIG. 1 and FIG. 2B of the present invention.

In the alternative embodiment of the present invention, the recording component 416 further includes a pause module for allowing the first user to pause the first media file 406a viewed by the first user; and a time-set module for setting a time interval to pause the first media file 406a at a fixed interval of time. The pause module and time-set module are explained in detail in conjunction with FIG. 3B of the present invention.

Embodiments of the invention may be configured to run on standard operating systems such as Microsoft Windows™, Unix™, Linux™, Apple Mac OS™, Apple iPhone™ iOS, Apple iPad™ iOS, Android™ or any other computer operating system. Embodiments of the invention may be created using standard programming and scripting languages such as C, C++, Fortran, Pascal, Basic, Perl, Python, Visual Basic, Visual C++, Visual C#, Java, Javascript, VBScript, HTML, DHTML, CSS, awk or any other programming or scripting language. However, it will be readily apparent to those with ordinary skill in the art that the various other types of operating systems and programming and scripting languages may also be used without deviating from the scope of the present invention.

The present invention offers various advantages such as allowing a parent to see how their child is performing on the actions done by the parent. Further, the present method and system allows the user to provide online teaching including but not limited to teaching a lesson, music, and karate to students and see how they are performing on the task provided. The task could be dancing, performing an acting sequence, singing and following a particular set of instructions. The present invention allows the users to interact while recording the feedback.

There has thus been shown and described a system and a method for assisting plurality of users interacting over a communication network, which fulfills all the items and advantages sought there for. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

1. A system for assisting plurality of users to interact over a communication network, the system comprising:
a first computing device of a first user comprising:
a first database for storing one or more media files and first computer executable components;
a first processor coupled with the first database to execute the first computer executable components, the first computer executable components comprising:
a selection component executable by the first processor for selecting a first media file by the first user; and
a first sharing component executable by the first processor for sharing the first media file with a second user;
a second computing device of the second user communicating to the first computing device over the communication network, the second computing device comprising:
a second database for storing one or more media files and second computer executable components;
a second processor coupled with the second database to execute the second computer executable components, the second computer executable components comprising:
a recording component executable by the second processor for recording a first feedback media file by the second user while viewing the first media file received from the first user; and
a second sharing component executable by the second processor for sharing the first feedback media file by the second user to the first user.

2. The system according to claim 1, wherein the selection component further comprising a creation module for creating a second media file by the first user.

3. The system according to claim 1, wherein the recording component further comprising a picture-in-picture window frame module for simultaneously displaying the first media file and the first feedback media file in separate window frames.

4. The system according to claim 3, wherein the picture-in-picture window frame module displays the first media file received from the first user in a main background window frame; and further displays the first feedback media file in a record window frame within the main background window frame.

5. The system according to claim 1, wherein the recording component further comprising:
a pause module for allowing the second user to pause the first media file received from the first user; and
a time-set module for setting a time interval to pause the first media file at a fixed interval of time.

6. The system according to claim 1, wherein the first computing device further comprising:
a second recording component for recording the second feedback media file while viewing the first media file,
wherein the first sharing component sends the recorded second feedback media file over the communication network.

7. The system according to claim 1, wherein the second computing device further comprising:
a second selection component for selecting at least one media file from the second database,
wherein the second sharing component for sharing the selected media file over the communication network.

8. A method for assisting plurality of users to interact over a communication network, the method comprising the step of:
selecting at least a first media file stored in a first computing device;
sharing the selected first media file from the first computing device to a second computing device;
recording a first feedback media file in the second computing device while viewing the first media file received from the first computing device; and
sharing the first feedback media file from the second computing device to the first computing device.

9. The method according to claim 8, further comprising a step of creating a second media file in the first computing device using a creation module.

10. The method according to claim 8, wherein the step of recording the first feedback media file comprises displaying the first media file and the first feedback media file simultaneously in separate window frames, using a picture-in-picture window frame module.

11. The method according to claim 10, wherein the first media file received from the first computing device is displayed in a main background window frame of the second computing device; and the first feedback media file is displayed in a record window frame within the main background window frame.

12. The method according to claim 8, further comprising a step of:
pausing the first media file received from the first computing device using a pause module; and
setting a time interval to pause the first media file at a fixed interval of time, using a time-set module.

13. The method according to claim 8, wherein the steps performed by the first computing device further includes the step of:
recording the second feedback media file while viewing the first media file; and
sharing the second feedback media file over the communication network.

14. The method according to claim 8, wherein the steps performed by the second computing device further includes the step of:
selecting the media files stored in the second computing device; and
sharing the selected media file from the second computing device over the communication network.

15. A system for assisting a first user to interact with a media file, the system comprising:
a database for storing one or more media files and computer executable components;
a processor coupled with the database to execute the computer-executable components comprising:
a selection component executable by the processor for selecting at least a first media file by the first user;
a viewing component executable by the processor for viewing the first media file selected by the first user; and
a recording component executable by the processor for recording a feedback media file by the first user while viewing the first media file.

16. The system according to claim 15, wherein the selection component further comprising a creation module to create a new media file.

17. The system according to claim 15, further comprising a sharing component to share the feedback media file to a second computing device.

18. The system according to claim 15, wherein the recording component further comprising a picture-in-picture window frame module for simultaneously displaying first media file and the feedback media file in separate window frames.

19. The system according to claim 18, wherein the picture-in-picture window frame module displays the first media file received from the first user in a main background window frame; and further displays the feedback media file in a record window frame within the main background window frame.

20. The system according to claim 15, wherein the recording component further comprising:
a pause module for allowing the first user to pause the first media file viewed by the first user; and
a time-set module for setting a time interval to pause the first media file at a fixed interval of time.
